(19) United States
(12) Patent Application Publication
(10) Pub. No.: US 2025/0226590 A1
(43) Pub. Date: Jul. 10, 2025

(54) TUNEABLE UNIT CELL ARRAY FOR A RECONFIGURABLE ANTENNA AND ASSOCIATED MANUFACTURING METHOD

(71) Applicant: COMMISSARIAT A L'ENERGIE ATOMIQUE ET AUX ENERGIES ALTERNATIVES, Paris (FR)

(72) Inventors: Denis MERCIER, Grenoble Cedex 09 (FR); Marjolaine ALLAIN, Grenoble Cedex 09 (FR); Bruno REIG, Grenoble Cedex 09 (FR); Francesco FOGLIA MANZILLO, Grenoble Cedex 09 (FR); Antonio CLEMENTE, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 19/012,063

(22) Filed: Jan. 7, 2025

(30) Foreign Application Priority Data
Jan. 10, 2024 (FR) FR2400202

(51) Int. Cl. H01Q 21/06; H01Q 3/36; H01Q 21/00

(52) U.S. Cl. CPC H01Q 21/065; H01Q 3/36; H01Q 21/0087

(57) ABSTRACT

A phased array reconfigurable antenna, intended to operate in sub-terahertz frequency bands, and more specifically, a tuneable unit cell array for a reconfigurable antenna and its manufacturing method. The radiating element array excited by controllable phase-shift signals (in a set of discrete values) includes a first molten silica-or quartz-based substrate, at least one pad coming from a cutting in a second molten silica-or quartz-based substrate, each pad being fixed to the first substrate to form a tuneable unit cell of the array, each cell including at least one phase change material switch. The antenna has application in medical imaging and industrial control, Earth and deep space observation, and for radars and broadband telecommunication systems.

### TECHNICAL FIELD

The present invention relates to an antenna array intended to operate in sub-terahertz frequency bands, for example around one or more hundred gigahertz. The present invention relates more specifically to a reconfigurable antenna array and its manufacturing method. The invention has, for example, application in medical imaging and industrial control, Earth and deep space observation, as well as for radars and broadband telecommunication systems.

### PRIOR ART

A reconfigurable antenna is an antenna which is capable of modifying its frequency and radiation properties dynamically, in a controlled and reversible manner. In order to provide a dynamic response, reconfigurable antennas can integrate actuators (such as phase change material-based radiofrequency (RF) switches, varactors, mechanical actuators or tuneable materials) which enable the intentional redistribution of RF currents over the surface of the antenna and produce reversible modifications of its properties; sometimes, phased array antennas are referred to. The reconfiguration capacity of reconfigurable antennas, including antenna arrays, is used to maximise the performance of the antenna in a changing scenario or to satisfy changing operating requirements.

A reconfigurable antenna array is constituted of the association of a set of reconfigurable unit radiating elements which correspond to a tuneable unit cell array disposed in a particular geometry, in one same frequency band, in order to produce a reconfigurable radiation diagram. A unit cell can be constituted of a substrate with low RF losses. A metal ground plane is deposited on one side of this substrate, and a patch or radiating metal element is deposited on the other side. A second substrate can be assembled on the radiating metal element, in order to improve its performance. A third metal layer can also be deposited on this second substrate, in order to even further improve the performance of the radiating element. This metal layer can itself comprise one or more secondary radiating elements excited by coupling by the first radiating element and behaves like a superposed patch antenna structure and makes it possible to improve the frequency band and the scanning range of the beam radiated by the array.

Most reconfigurable antennas are obtained today by implementations of manufacturing methods which consist of transferring a first wafer comprising actuators on at least one second wafer comprising cells based on a material with low RF losses. This type of reconfigurable antenna is obtained today by implementations of manufacturing methods which consist of manufacturing tuneable unit radiating elements with RF switches on a first wafer and of transferring a second entire substrate with elements enabling the improvement of the overall performance of the antenna. The tuneable unit element is thus constituted of the stack of 2 substrates made of material with low RF losses with three metallising levels (one on each side of the stack, and one between the two substrates).

For example, the scientific document by P. Pahlavan et al., entitled, “Metamaterial Based Compact Patch Antenna Array for Antenna-in-Package Solutions in Frequency Handover Applications,” and which appeared in 2023 IEEE 73rd Electronic Components and Technology Conference (ECTC), Orlando, FL, USA, 2023, pp. 475-480 (doi: 10.1109/ECTC51909.2023.00085) discloses an antenna cell array of dimensions 2×2:
a. manufactured from:
   i. a first molten silica-based wafer, having a thickness of 330 microns and
   ii. a second molten silica-based wafer, having a thickness of 180 microns assembled to the first wafer, and
b. further comprising three metallising levels, one of which for constituting a supply line, one for constituting a connecting plug, or patch, per cell and one for constituting a ground plane, the latter serving as an interface between the two wafers.

The antenna proposed in this scientific document has the advantages:
a. of avoiding problems linked to different thermal dilation coefficients between the wafers to be assembled, because they have one same basic composition, namely of molten silica,
b. of avoiding having to form interconnecting vias through the molten silica of each of the two wafers, which again would have been able to pose manufacturing problems, in particular in terms of thermal balance.

However, the solution proposed in this scientific document has, like a lot of other manufacturing methods, the disadvantage of involving the handling of two wafers, which are relatively fine, for wafer diameters of 100 mm, from which assembly difficulties and risks of damaging at least one of the two wafers arise.

A transmission unit cell for a reconfigurable antenna and an antenna array respectively, is moreover known, from patent documents US 2017/0033462 A1 and U.S. Pat. No. 11,757,203 B2.

An aim of the present invention is to overcome at least one of the disadvantages of the prior art, preferably by preserving the advantages that it has.

### SUMMARY

To achieve this aim, according to a first aspect of the invention, a tuneable unit cell array for a reconfigurable antenna is provided, comprising:
a. a first substrate based on one or the other from among molten silica, quartz and a glass having a loss tangent less than 0.005 at frequencies greater than 100 GHz,
b. at least two pads coming from a cutting in at least one second substrate based on one or the other from among molten silica, quartz or a glass having a loss tangent less than 0.005 at frequencies greater than 100 GHz, said at least two pads being fixed to the first substrate to form at least two unit cells of the tuneable unit cell array, each tuneable unit cell comprising at least one phase change material switch comprised by, or formed in, or located in, the first substrate, and each pad being able to have a different thickness.

According to a second aspect of the invention, a method for manufacturing a tuneable unit cell array for a reconfigurable antenna is provided, comprising:
a. providing a first substrate based on one or the other from among molten silica, quartz and a glass having a loss tangent less than 0.005 at frequencies greater than 100 GHz, and comprising a phase change material switch matrix,
b. providing a second substrate based on one or the other from among molten silica, quartz and a glass having a loss tangent less than 0.005 at frequencies greater than 100 GHz,
c. cutting at least two first pads in one from among the first substrate and the second substrate,
d. transferring said at least two first pads on the other from among the first substrate and the second substrate,
   such that each first pad forms, with the part of the substrate onto which it is transferred, at least one tuneable unit cell of the tuneable unit cell array.

The invention, according to each of its different aspects, can thus consist of a first substrate on which is fixed by pieces, or equivalently by pads, a second substrate in which the pieces or pads have been cut. It is thus advantageously avoided to have to transfer a large substrate (larger than 50 mm) on another substrate of equivalent dimensions, thus relaxing the flatness stresses of the assembly surfaces and/or decreasing the risk of breaking the substrates during their handling and/or their manufacture, when they are subjected to thermomechanical stresses. And, the option of having pads of different thicknesses is advantageously had, making it possible to adjust or fix the focalisation of the antenna.

### BRIEF DESCRIPTION OF THE FIGURES

The aims, objectives, as well as the features and advantages of the invention will best emerge from the detailed description of an embodiment of the latter, which is illustrated by the following accompanying drawings, in which:

FIG. 1 schematically represents a partial, cross-sectional view of a tuneable unit cell array according to a first embodiment of the first aspect of the invention.

FIG. 2 schematically represents a perspective view of a tuneable unit cell array according to the first aspect of the invention.

FIGS. 3 to 10 schematically represent partial, cross-sectional views illustrating a first embodiment of the second aspect of the invention.

FIGS. 11, 12 and 13, 14 and 15 schematically represent partial, cross-sectional views illustrating, respectively, three variants of embodiments of the first aspect of the invention and implementation of the second aspect of the invention relative to those illustrated in FIG. 10.

FIGS. 16 to 19 schematically represent partial, cross-sectional views illustrating a second embodiment of the second aspect of the invention.

The drawings are given as examples and are not limiting of the invention. They constitute principle schematic representations, intended to facilitate the understanding of the invention, and are not necessarily to the scale of practical applications. In particular, the relative thicknesses of different layers illustrated are not necessarily representative of reality.

### DETAILED DESCRIPTION

Before starting a detailed review of embodiments of the invention, optional features are stated below, which can optionally be used in association or alternatively:

According to an example of the first aspect of the invention, the first substrate has a characteristic transverse dimension greater than or equal to 100 mm, even greater than or equal to 200 mm, and/or said at least two pads cut in the second substrate, each have a characteristic transverse dimension greater than or equal to 200 μm and strictly less than 50 mm, preferably less than 5 mm.

According to an example of the first aspect of the invention, the cutting of said at least two first pads comprises a cutting, for example by laser or by saw, in the thickness of the substrate in question.

According to an example of the first aspect of the invention, the phase change material switch is at least partially encapsulated in silicon oxide.

According to an example of the first aspect of the invention, at least four, preferably sixteen, pads are fixed to the first substrate, so as to give the tuneable unit cell array the shape of a two-dimensional matrix of tuneable unit cells.

According to an example of the first aspect of the invention, at least one pad comprises a primary layer based on one or the other from among molten silica, quartz and a glass having a loss tangent less than 0.005 at frequencies greater than 100 GHz, and a pattern or structuring of a metal layer and/or a radiating element (for example, a patch antenna) on the face of the primary layer which is opposite that by which said primary layer is fixed to the first substrate.

According to an example of the first aspect of the invention, at least one pad is fixed to the first substrate through an adhesive layer.

According to an example of the first aspect of the invention, at least one pad is fixed to the first substrate by thermocompression of a metal layer deposited on said at least one pad with metal layer deposited on the first substrate.

According to an example of the first aspect of the invention, at least one pad is fixed to the first substrate by remelting of metal balls, for example, gold-based, deposited on at least one from among a metal layer deposited on said at least one pad and a metal layer deposited on the first substrate.

According to any one of the three preceding examples of the first aspect of the invention, the phase change material switch is comprised by, or formed in, or located in, the first substrate.

According to an example of the first aspect of the invention, at least one pad is fixed to the first substrate by hybrid bonding, said at least one pad and the first substrate having, at the fixing of said at least one pad on the first substrate, surface structurings being superposed substantially to one another.

According to an example which is alternative to the preceding one, at least one pad is fixed to the first substrate by remelting metal balls, for example, gold-based, deposited beforehand on at least one from among a metallising layer deposited on said at least one pad and a metallising layer deposited on the first substrate, said at least one pad and the first substrate having, at the fixing of said at least one pad on the first substrate, surface structurings being superposed substantially to one another.

According to the six examples above, the tuneable unit cell array according to the first aspect of the invention can advantageously have as many configurations as there are of fixing each pad to the first substrate. With there being are least four of these ways, these are four fixing configurations, and therefore four embodiments of each tuneable unit cell, which can be considered for each of the pads fixed to the first substrate. This makes it possible to choose the fixing configuration which is the most compatible with the thermal budget that the pads and the first substrate can support.

According to an example of the first aspect of the invention, the tuneable unit cell array comprises pads of different thicknesses to one another. It is thus possible to modulate, in an advantageously increased manner, the focalisation of the beam transmitted or reflected by the tuneable unit cell array.

According to an example of the first aspect of the invention, the tuneable unit cell array further comprises, coupled, even connected, to each phase change material switch, a thermal actuation guide, for example, of an optical or electrical nature. According to an example, the manufacturing of the thermal actuation guide can be done during the manufacture of the first substrate comprising the phase change material switch.

According to an example of the first aspect of the invention, the thermal actuation guide, like the phase change material switch, is at least partially encapsulated in silicon oxide.

According to an example of the first aspect of the invention, the tuneable unit cell array further comprises, for each phase change material switch, a metallising level forming an interconnecting RF line and/or a radiating element (e.g. a patch antenna), of the phase change material switch. According to this example, the tuneable unit cell array does not require an additional interconnecting level, which makes it possible to save at least one metal level.

According to an example of the first aspect of the invention, the metallising level, like the phase change material switch, is at least partially encapsulated in silicon oxide.

According to an example of the first aspect of the invention, the tuneable unit cell array has no silicon. The radiofrequency radiation losses are thus limited.

According to another example of the first aspect of the invention, the tuneable unit cell array can comprise at least one metal interconnecting level between said at least two pads and the first substrate, which is accessible without etching the constitutive material of said at least two pads and/or of the first substrate to ensure an electrical connection between said at least two pads and the first substrate at their fixing interface. In other words, the tuneable unit cell array advantageously has no vias through the material, on the basis of which said at least two pads and/or the first substrate are constituted. Difficulties in respecting the thermal budget during manufacture are thus avoided, the low-temperature methods being poorer, and/or the bonding with metal continuity over several levels which demand additional steps and increase the cost, while increasing the risk of breaking, is thus avoided.

According to another example of the first aspect of the invention, said at least two pads and the first substrate are constituted on the basis of the same material chosen from among molten silica, quartz and a glass having a loss tangent less than 0.005 at frequencies greater than 100 GHz. According to this example, the thermal dilation coefficients of said at least one pad and the first substrate are of the same value, which advantageously limits the thermomechanical stresses during the manufacture of the tuneable unit cell array.

According to an example of the second aspect of the invention, the cutting of said at least two first pads comprises a cutting, for example, by laser or by saw, in the thickness of the substrate in question.

According to an example of the second aspect of the invention, each first pad forms with the part of the substrate onto which it is transferred, one single tuneable unit cell of the tuneable unit cell array.

According to an example of the second aspect of the invention, each from among the first and the second substrate has a characteristic transverse dimension greater than or equal to 100 mm, even greater than or equal to 200 mm, and/or said at least two pads, each have a characteristic transverse dimension greater than or equal to 200 μm and strictly less than 50 mm, preferably less than 5 mm.

According to an example of the second aspect of the invention, each phase change material switch is intended to partially form a tuneable unit cell.

According to an example of the second aspect of the invention, the first substrate and the second substrate are based on the same material.

According to an example of the second aspect of the invention, at least four, preferably at least sixteen, pads are cut then transferred, such that the pads form, with the parts of the substrate on which they are transferred, a tuneable unit cell array taking the form of a tuneable unit cell array.

According to an example of the second aspect of the invention, the method comprises the provision of at least one third substrate, the cutting of at least one third pad in the third substrate and the transfer of said at least one third pad onto the substrate on which said at least two first pads have been transferred, the third substrate preferably having a different thickness of the substrate in which said at least two first pads have been cut. Thus, the pads can come from different substrates, and the latter can, for example, have different thicknesses to one another, such that the pads which are cut there, can be transferred onto one same substrate to form tuneable unit cells of different thicknesses in one same tuneable unit cell array.

According to an example of the second aspect of the invention, the provision of the first substrate comprises:
a. the provision of a silicon-based growth substrate,
b. the formation of the phase change material switches on the growth substrate,
c. the formation of thermal actuation guides of the phase change material switches,
d. the formation of a metallising level intended to form interconnecting lines and/or radiating elements (for example, patch antennas) of each phase change material switch, and
e. the transfer of a first layer based on one or the other from among molten silica, quartz and a glass having a loss tangent less than 0.005 at frequencies greater than 100 GHz,
f. if necessary, the formation of a ground plane on said layer based on one or the other from among molten silica, quartz and a glass having a loss tangent less than 0.005 at frequencies greater than 100 GHz, then,
g. the removal by grinding of the growth substrate, each phase change material switch, each thermal actuation guide and each interconnecting line or radiating element being located at least partially encapsulated in silicon oxide. It is thus possible to provide the first substrate by using conventional microelectronic manufacturing methods, and in particular, in CMOS (Complementary Metal Oxide Semiconductor) foundries.

According to an example of the second aspect of the invention, the transfer of said first layer is done through a silicon oxide layer.

According to an example of the second aspect of the invention, the method further comprises, after the grinding of the growth substrate, at least one step of opening, for example, by etching, of a silicon oxide layer to the right of an interconnecting line of the radiating metal element.

According to an example of the second aspect of the invention, the provision of the second substrate comprises:
a. the provision of a support substrate based on one or the other from among molten silica, quartz and a glass having a loss tangent less than 0.005 at frequencies greater than 100 GHz, and
b. the formation, on the support substrate, of a metal layer, and
c. the etching of the metal layer to form patterns or structurings for each tuneable unit cell to be formed, and in which the cutting step relates to the second substrate and consists of cutting pads in the second substrate, by rotating around each pattern or structuring.

According to an example of the second aspect of the invention, the transfer of at least one first pad is done through an adhesive layer.

According to an example of the second aspect of the invention, the transfer of at least one first pad is done by thermocompression of a metal layer of said at least one pad with a metal layer of the first substrate.

According to an example of the second aspect of the invention, the transfer of at least one first pad is done by remelting metal balls, for example, gold-based, deposited beforehand on at least one from among a metal layer of said at least one pad and a metal layer of the first substrate.

According to any one of the three preceding examples, the cutting of said at least two first pads is done in the second substrate.

According to an example of the second aspect of the invention, the transfer of at least one first pad is done by hybrid bonding, said at least one pad and the first substrate having, at the fixing of said at least one first pad on the first substrate, surface structurings being superposed substantially to one another.

According to an example of the second aspect of the invention, the transfer of at least one first pad is done by remelting metal balls, for example, gold-based, deposited beforehand on at least one from among a metal layer of said at least one pad and a metal layer of the first substrate, said at least one pad and the first substrate having, at the fixing of said at least one pad on the first substrate, surface structurings being superposed substantially to one another.

According to any one of the two preceding examples, the cutting of said at least two first pads is done in the first substrate.

By a film or a layer based on a material A, this means a film or a layer comprising this material A and optionally other materials.

By a parameter “substantially equal to/greater than/less than” a given value, this means that this parameter is equal to/greater than/less than the given value, plus or minus 20%, even 10%, of this value. By a parameter “substantially between” two given values, this means that this parameter is, as a minimum, equal to the lowest given value, plus or minus 20%, even 10%, of this value, and as a maximum, equal to the greatest given value, plus or minus 20%, even 10%, of this value.

It is specified that, in the scope of the present invention, the terms “on”, “surmounts”, “overhangs”, “covers”, “underlying” and their equivalents do not necessarily mean “in contact with”. Thus, for example, the transfer, the application or the deposition of a first layer on a second layer, does not compulsorily mean that the two layers are directly in contact with one another, but means that the first layer covers at least partially the second layer by being either directly in contact with it, or by being separated from it by at least one other layer or at least one other element.

Unless specified otherwise, when reference is made to two elements connected to one another, this means directly connected, without intermediate elements other than conductors, and when reference is made to two elements coupled to one another, this means that these two elements can be connected or be coupled through one or more other elements, or by electromagnetic coupling without being directly connected.

Generally, the phase change materials are materials capable of alternating, under the effect of a temperature variation, between a crystalline phase and an amorphous phase, the amorphous phase having an electrical resistance greater than that of the crystalline phase.

In the description below, the substrate, film or layer thicknesses are generally measured along directions perpendicular to the main extension plane of the substrate, of the film, or of the layer.

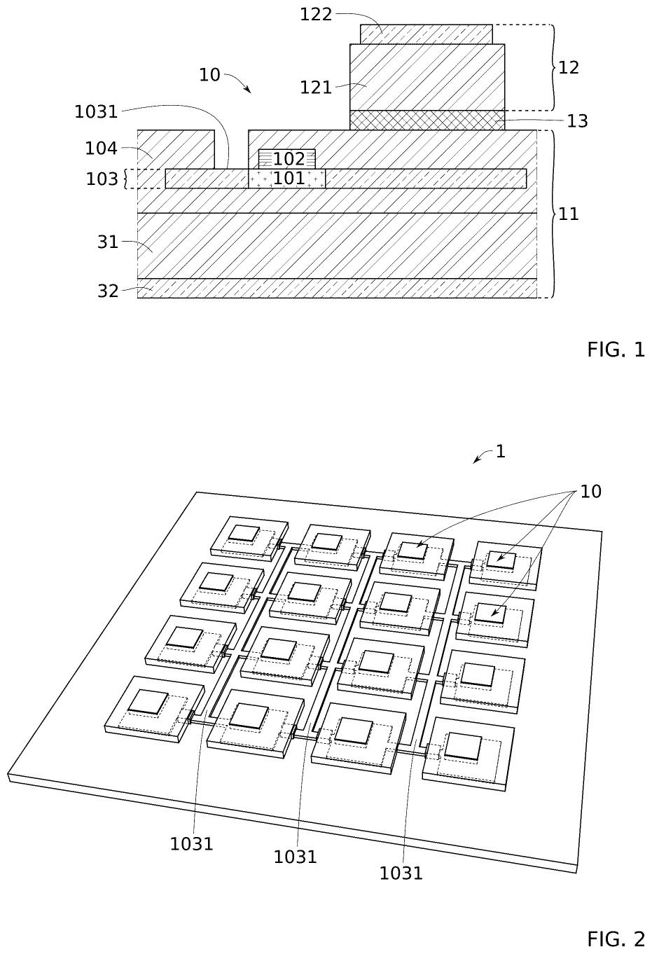

A first embodiment of the tuneable unit cell array 1 according to the first aspect of the invention is described below in reference to FIG. 1.

The tuneable unit cell array 1 for a reconfigurable antenna, such as illustrated in FIG. 1, comprises:
a. a first substrate 11 based on one or the other from among molten silica, quartz and a glass having a loss tangent less than 0.005 at frequencies greater than 100 GHz, and
b. at least one pad 12 coming from a cutting in a second substrate 20 based on one or the other from among molten silica, quartz and a glass having a loss tangent less than 0.005 at frequencies greater than 100 GHz.

Each pad 12 is fixed to the first substrate 11, in this case, through an adhesive layer 13, to form a tuneable unit cell 10 of the tuneable unit cell array 1. Each tuneable unit cell 10 comprises at least one phase change material switch 101 comprised by, or formed in, or located in, the first substrate 11.

The schematic representation that FIG. 1 offers is only partial. All of the tuneable unit cell array 1 is itself illustrated in FIG. 2, which shows an organisation in matrix form of 4×4 tuneable unit cells 10. The square nature of the two-dimensional matrix, as well as the number of tuneable unit cells 10 that it can comprise, are however not limited to the example illustrated in FIG. 2. Also, there could be several phase change material switches 101 and/or several radiating elements in the same tuneable unit cell, on the contrary, of the representation that FIG. 2 offers.

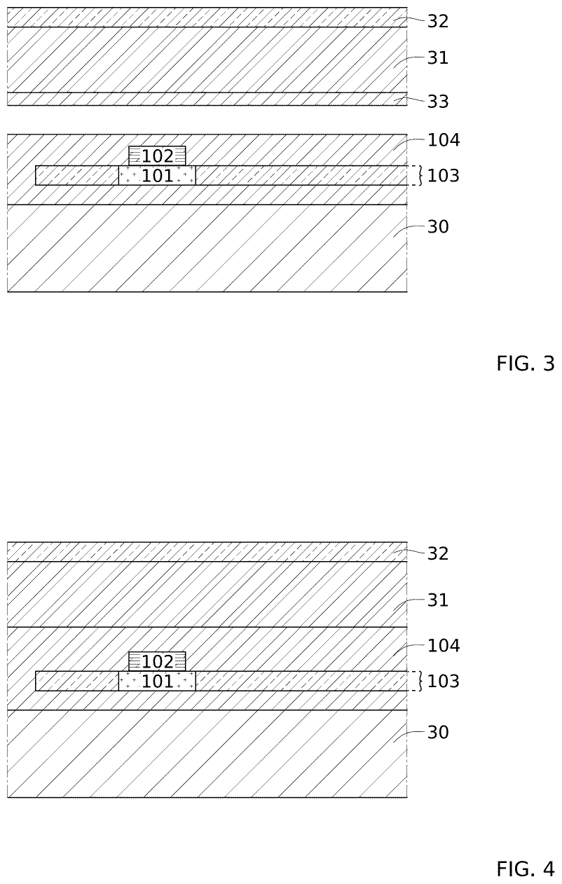

The embodiments that FIG. 1 illustrates and relatively equivalent to that that FIG. 10 illustrates. FIGS. 3 to 9 thus also illustrate an embodiment of the manufacturing method of the embodiment of the array which is illustrated in FIG. 1, and an embodiment of the manufacturing method of the embodiment which is illustrated in FIG. 10. This embodiment illustrated in FIGS. 3 to 9 is described below in reference to said figures.

As illustrated in FIG. 3, the embodiment of the manufacturing method according to the second aspect of the invention first comprises the provision of a silicon-based growth substrate 30 on which are formed phase change material switches 101, thermal actuation guides 102 of said switches, as well as a metallising level 103 intended to form an interconnecting line and/or a radiating element 1031 per cell 10, such as it appears in FIG. 6.

The implementation steps described above are the first steps of a whole which makes it possible to obtain the provision of the abovementioned first substrate 11. Said provision is followed by the following steps.

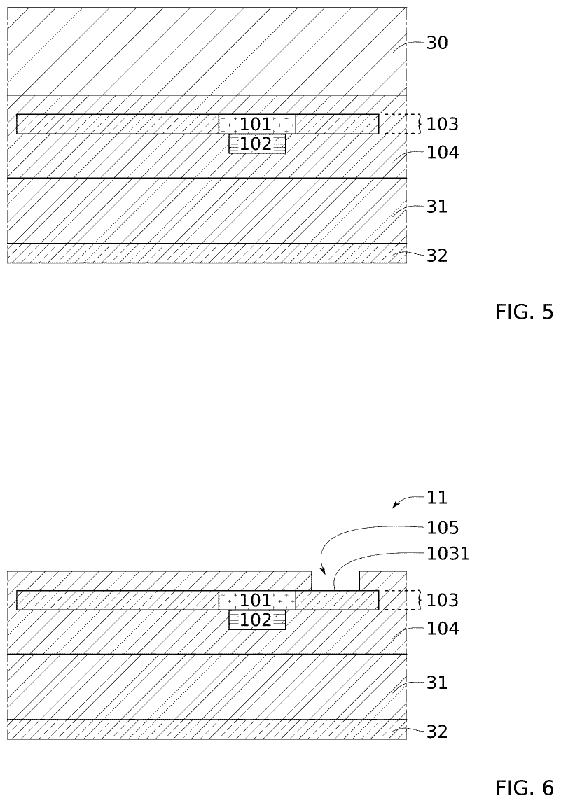

A first layer 31 based on one or the other from among molten silica, quartz and a glass having a loss tangent less than 0.005 at frequencies greater than 100 GHz is transferred onto an encapsulating silicon oxide layer 104, above the growth substrate 30, the phase change material switches 101, the thermal actuation guides 102 and the metallising level 103. This transfer can be done through a silicon oxide layer 33 deposited on the face of the first layer 31 by which the transfer is intended to be done. The transfer is therefore done between two silicon oxide layers 33 and 104. Thus, a stack such as illustrated in FIGS. 4 and 5 is reached.

If necessary, the provision of the first substrate 11 can comprise the formation of a ground plane 32 on the face of the layer 31 which is opposite that by which the transfer is intended to be done.

Once the transfer is done, the provision of the first substrate 11 comprises the grinding of the growth substrate 30, until reaching the silicon oxide encapsulating the phase change material switches 101, the thermal actuation guides 102 and the metallising level 103.

Once the growth substrate 30 is ground, a step of opening 105, for example by etching, the silicon oxide layer 104 to the right of a part of the metallising level 103 is provided, to form the interconnecting line and/or the radiating metal element 1031, and thus reach a first substrate 11 such as illustrated in FIG. 6.

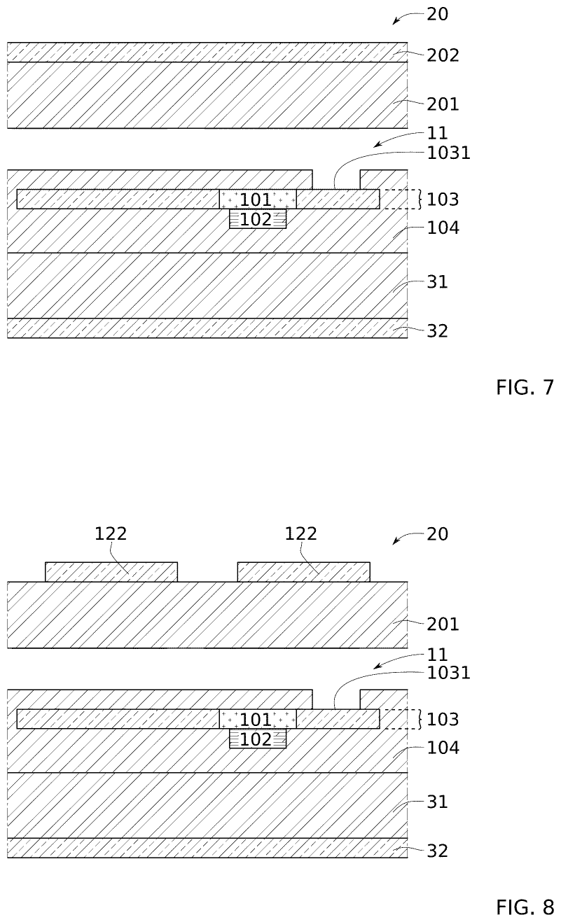

The implementation method presently detailed then comprises, in reference to FIG. 7, the provision of a second substrate 20 based on one or the other from among molten silica, quartz and a glass having a loss tangent less than 0.005 at frequencies greater than 100 GHz. More specifically, the second substrate 20 comprises a layer 201 based on one or the other from among molten silica, quartz and a glass having a loss tangent less than 0.005 at frequencies greater than 100 GHz, on which a metallising level 202 can be deposited, which, as illustrated in FIG. 8, can be etched, so as to form a plurality of connecting plugs 122.

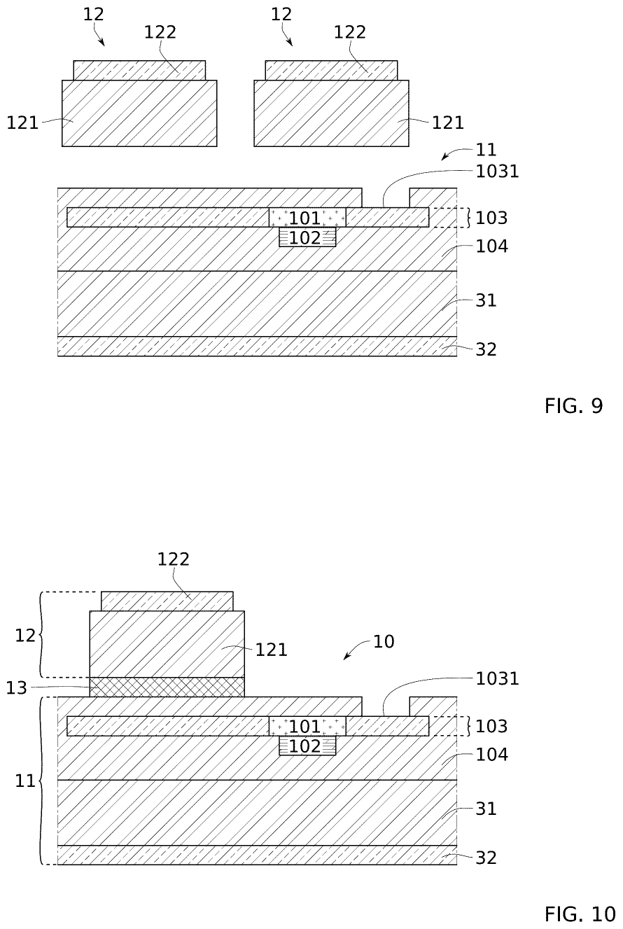

In reference to FIG. 9, the second substrate 20 is then cut into pads 12. Preferably, each pad 12 can be surmounted by at least one structuring in the abovementioned metal layer 122. If FIG. 9 illustrates a cutting of the second substrate 20 into two pads 12, it is understood that the cutting of the second substrate 20 can lead to the manufacturing of a plurality of at least four pads 12, preferably at least sixteen pads 12, even more.

In this case, it is noted that the first and second substrates 11 and 12 preferably have a characteristic transverse dimension greater than or equal to 100 mm, while each pad 12 can have a characteristic transverse dimension greater than or equal to 200 μm, but strictly less than 50 mm and preferably less than or equal to 35 mm. There is therefore sufficient space on the first substrate 11 to transfer a plurality of pads 12 there, going beyond four, even beyond sixteen. This will be even further verified when the characteristic transverse dimension of the first substrate 11 will be substantially equal to 200 mm, even 300 mm, as is the case of most current first substrates 11. However, they remain that each tuneable unit cell is intended to comprise at least one phase change material switch 101, accompanied by its thermal actuation guide 102.

Preferably, the first substrate 11 and the second substrate 12 are based on the same material. Thus, the thermal dilation coefficients of said at least one pad 12 and of the first substrate 11 are of the same value, which advantageously limits the thermomechanical stresses during the manufacturing of the tuneable unit cell array 1.

It is possible to consider that the cutting of the pads 12, for example, by using a laser, is done around each pattern or structuring of the metal layer 122 in the thickness of the second substrate 20, and that each pattern or structuring of the metal layer 122 is intended to partially form a tuneable unit cell 10. It is further possible to consider that the cutting of the pads 12 is done such that pattern or structuring of the metal layer 122 leads to a pad 12 and that the patterns or structurings of the metal layer 122 etched in the metallising level 202 are distributed over the entire surface of the second substrate 20. Subsequently, the cutting in the second substrate 20 of the plurality of pads 12 which is defined there by the patterns or structurings of the metal layer and the transfer of the pads 12 thus obtained on the first substrate 11 returns, as it were, to recreating by pads, the second substrate 20 on the first substrate 11, a distance at least equal to the width of the material of the second substrate destroyed during its cutting into pads 12, being arranged between pads 12, first neighbouring ones between them which have been transferred.

The transfer of each pad 12 is done such that each pad 12 forms, with the part of the first substrate 11 onto which it is transferred, a tuneable unit cell 10 of the tuneable unit cell array 1. It must be noted that the transfer of each pad 12 could lead to the production of a plurality of tuneable unit cells 10, because, for example, the cutting of the second substrate 20 into pads 12 would be done so as to obtain, on each pad 12, a matrix of 2×2, even 4×4, even more, patterns or structurings of the metal layer 122.

As already mentioned above, said transfer can be done through a simple adhesive layer 13, to reach a tuneable unit cell array 1 such as illustrated partially in FIG. 10 (or equivalently, in FIG. 1) is such as represented in its entirety in FIG. 2.

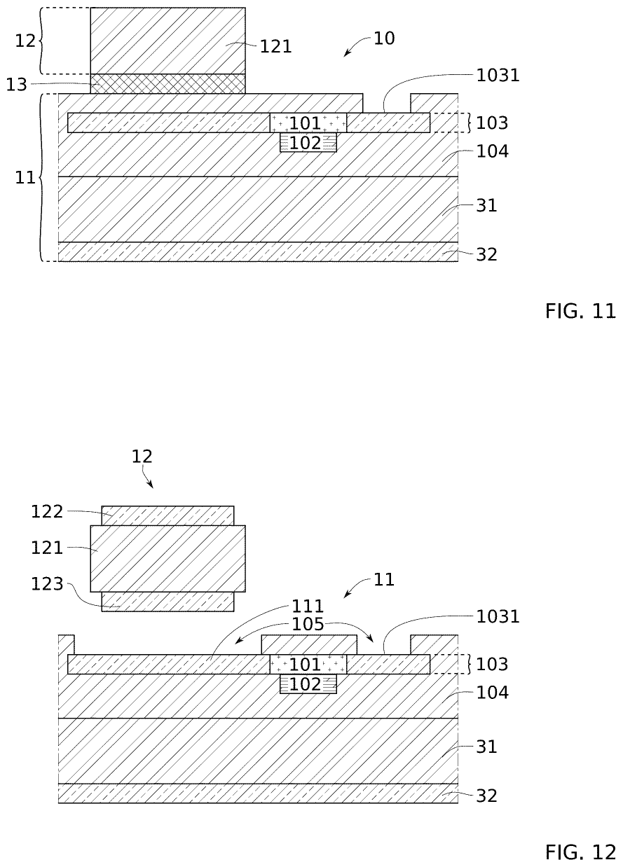

The embodiment of the tuneable unit cell array 1 according to the first aspect of the invention which is illustrated in FIG. 11 is a variant of that illustrated in FIG. 10; it shows that the metal pattern (or the structuring) 122 which covers or overhangs each pad 12 is optional.

In a non-illustrated manner in the figures, a person skilled in the art will understand that it is possible that certain pads 12 to be transferred onto the first substrate 11 do not come from the second substrate 20, but from a third substrate having, for example, a different thickness from that of the second substrate 20, and more specifically, a layer based on one from among molten silica, quartz and a glass having a loss tangent less than 0.005 at frequencies greater than 100 GHz having a different thickness from that of the layer 201 of the second substrate 20. Thus, the pads 12 can come from different substrates, and the latter can, for example, have different thickness to one another, such that the pads 12 which are cut there, can be transferred onto one same first substrate 11 for a tuneable unit cell array 1, the tuneable unit cells 10 of which have different thicknesses to one another.

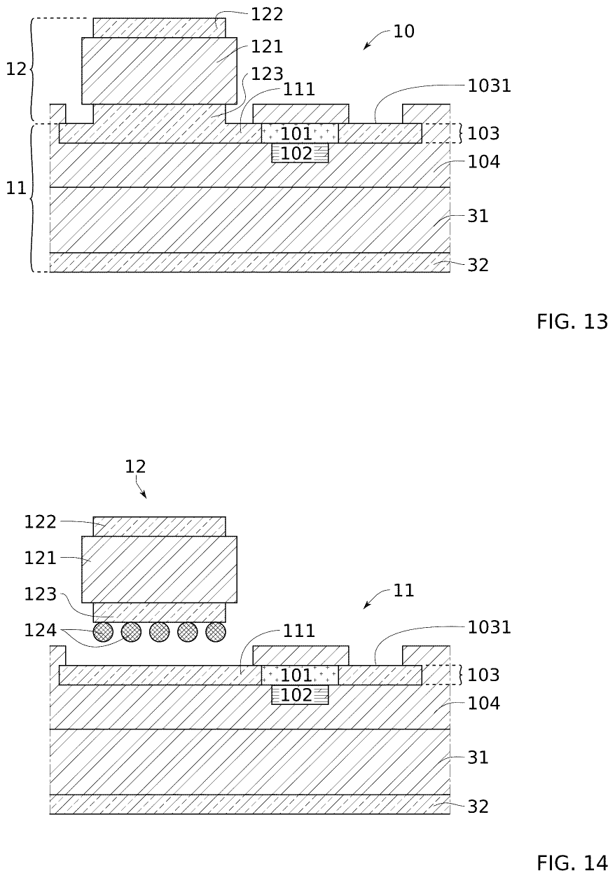

The embodiment illustrated in FIG. 12 can be considered as a variant of the embodiment illustrated in FIG. 10. To obtain the embodiment of the tuneable unit cell array 1 which is illustrated in FIG. 12, a second step of opening 105, for example by etching, the silicon oxide layer 104 can be provided to the right of a part of the metal layer 1031 of the other side of the phase change material switch 101 relative to the abovementioned first opening 105, and each pad 12 can comprise a metal layer 123, by which it is intended to be transferred, onto the first substrate 11, to the right of the second opening 105, for example, by thermocompression between the connecting plug 123 and the part of the metal layer 1031 which is exposed via the second opening 105. It is noted that again, the connecting plug 122 illustrated in FIG. 12 is optional. Once the transfer is done, a tuneable unit cell array 1 such as illustrated partially in FIG. 13 is obtained.

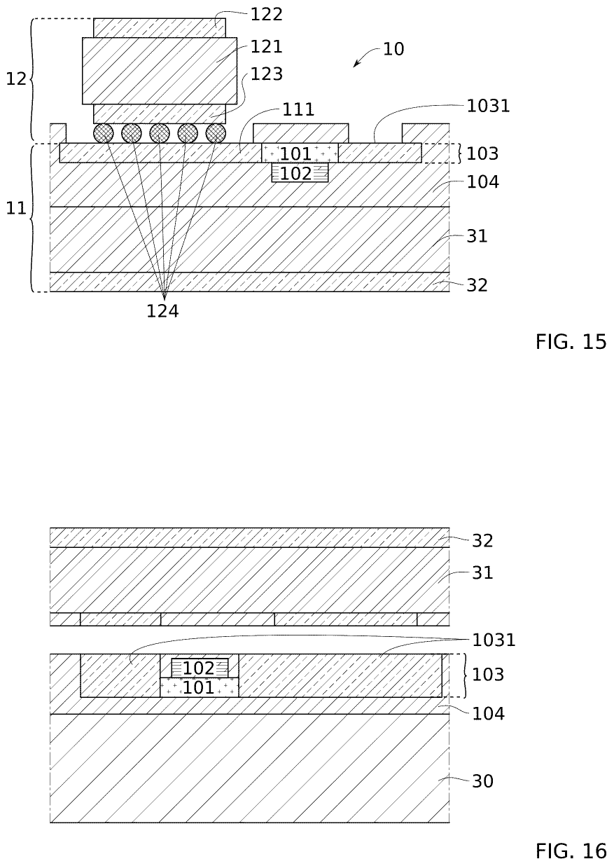

According to a variant of the embodiment illustrated in FIG. 12, this variant being illustrated in FIGS. 14 and 15, the transfer of each pad 12 can further involve the melting of metal balls 124, for example, gold-based, deposited, before the transfer, onto the connecting plug 123 or in the second opening 105. According to this variant, the embodiments of the tuneable unit cell array 1 are reached, which is illustrated in FIG. 15.

Another embodiment of the first aspect of the invention and implementation of the second aspect of the invention is illustrated in FIGS. 16 to 19.

According to this other embodiment, and in reference to FIG. 16, the provision of the first substrate 11 comprises:
a. the provision of the silicon-based growth substrate 30,
b. the formation of phase change material switches 101 on the growth substrate 30,
c. the formation of thermal actuation guides 102 of the phase change material switches 101, and
d. the formation of a metallising level 103 flush with locations to form at least one metal layer 1031 of each phase change material switch 101, then
e. the transfer of a substrate comprising a first layer 31 based on one or the other from among molten silica, quartz and a glass having a loss tangent less than 0.005 at frequencies greater than 100 GHz, if necessary a ground plane 32 on said layer 31 extending over the face of this layer which is opposite the growth substrate 30, and a surface structuring on the face of the layer 31 which is intended to be coupled to said at least one metal layer 1031 of each phase change material switch 101.

FIG. 16 shows that the two assembled elements have, on their assembly face, surface structurings corresponding to one another.

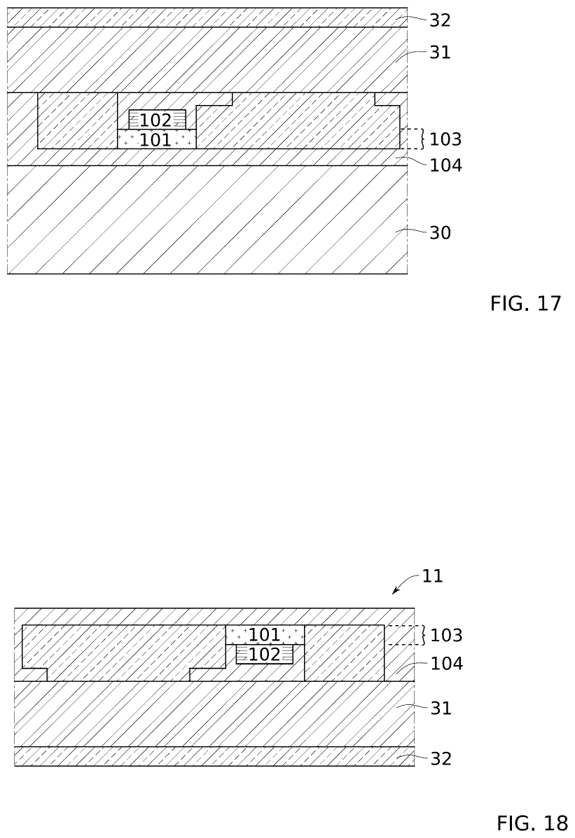

Once the assembly is done, as illustrated in FIG. 17, the silicon can be ground, to reach a first substrate 11 such as illustrated in FIG. 18, with no silicon.

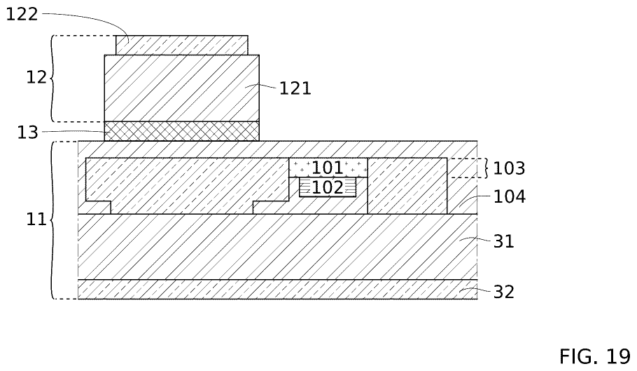

Starting with the substrate illustrated in FIG. 18, it is possible to transfer there, as illustrated in FIG. 19, a pad 12 such as described above, and, in the example illustrated, by an adhesive layer 13. The other transfer methods described above naturally remain portable to the embodiment described in reference to FIG. 19.

The embodiments described above have a common factor that the cut substrate is not that comprising the active elements of the tuneable unit cells 10, namely the phase change material switches 101 and their thermal actuation guide 102. On the contrary, in the embodiments of the invention which are illustrated in FIGS. 20 to 25, it is the substrate in which the active elements of the tuneable unit cells 10 are located, which is cut.

The different embodiments of the tuneable unit cell array 1 which are described above advantageously make it possible to avoid having to transfer a large entire substrate (>50 mm of transverse dimension) onto another entire substrate, thus relaxing the flatness stresses of the assembly surfaces and/or decreasing the risk of breaking the substrates during their handling and/or their manufacture, when they are subjected to thermomechanical stresses. Another advantage consists of that it is thus possible to fix pads 12 of different thicknesses to one another, to the first substrate 11.

In this case, it is reminded that the present invention relates to a reconfigurable phase-shift array antenna, intended to operate in millimetric and sub-terahertz frequency bands, for example of between 100 Ghz and 500 GHz.

The invention is not limited to the embodiments described above, and extends to all the embodiments covered by the invention.

1. A tuneable unit cell array for a reconfigurable antenna, comprising:
a first substrate based on or the other from among molten silica, quartz and a glass having a loss tangent less than 0.005 at frequencies greater than 100 GHz,
at least two pads coming from a cutting in at least one second substrate based on one or the other from among molten silica, quartz and a glass having a loss tangent less than 0.005 at frequencies less than 100 GHz,
said at least two pads being fixed to the first substrate to form at least two tuneable unit cells of the tuneable unit cell array, each tuneable unit cell comprising at least one phase change material switch comprised in the first substrate and each pad being able to have a different thickness.

2. The tuneable unit cell array according to claim 1, wherein at least four pads are fixed to the first substrate so as to give the tuneable unit cell array the shape of a two-dimensional matrix of tuneable unit cells.

3. The tuneable unit cell array according to claim 1, wherein at least one pad comprises a primary layer based on one or the other from among molten silica, quartz and a glass having a loss tangent less than 0.005 at frequencies greater than 100 GHz, and a pattern or structuring of a metal layer and/or a radiation element on the face of the primary layer which is opposite that by which said primary layer is fixed to the first substrate.

4. The tuneable unit cell array according to claim 1, wherein at least one pad is fixed to the first substrate by remelting metal balls, for example, gold-based, deposited beforehand on at least one from among a metal layer deposited on said at least one pad and a metal layer deposited on the first substrate.

5. The tuneable unit cell array according to claim 1, wherein at least one pad is fixed to the first substrate by hybrid bonding, said at least one pad and the first substrate having, at the fixing of said at least one pad on the first substrate, surface structurings being superposed substantially to one another.

6. The tuneable unit cell array according to claim 1, wherein at least one pad is fixed to the first substrate by remelting metal balls, for example, gold-based, deposited beforehand on at least one from among a metal layer deposited on said at least one pad and a metallising layer deposited on the first substrate, said at least one pad and the first substrate having, at the fixing of said at least one pad on the first substrate, surface structurings being superposed substantially to one another.

7. The tuneable unit cell array according to claim 1, comprising pads of different thicknesses to one another.

8. The tuneable unit cell array according to claim 1, further comprising, coupled, even connected, to each phase change material switch, a thermal actuation guide.

9. The tuneable unit cell array according to claim 1, further comprising, for each phase change material switch, a metallising level forming an interconnecting RF line and/or a radiating metal element of the phase change material switch.

10. A method for manufacturing a tuneable unit cell array for a reconfigurable antenna, comprising:
providing a first substrate based on one or the other from among molten silica, quartz and a glass having a loss tangent less than 0.005 at frequencies greater than 100 GHz, and comprising a phase change material switch matrix,
providing a second substrate based on one or the other from among molten silica, quartz and a glass having a loss tangent less than 0.005 at frequencies greater than 100 GHz,
cutting at least two first pads in one from among the first substrate and the second substrate,
transferring said at least two first pads on the other from among the first substrate and the second substrate,
such that each first pad forms with the part of the substrate onto which it is transferred, at least one tuneable unit cell of the tuneable unit cell array.

11. A manufacturing method according to claim 10, wherein at least four pads are cut then transferred, such that the pads form, with the parts of the substrate onto which they are transferred, a tuneable unit cell array taking the form of a tuneable unit cell array.

12. The manufacturing method according to claim 10, comprising the provision of at least one third substrate, the cutting of at least one third pad in the third substrate and the transfer of said at least one third pad onto the substrate onto which have been transferred said at least two first pads, the third substrate having a different thickness of the substrate in which said at least two first pads have been cut.

13. The manufacturing method according to claim 10, wherein the provision of the first substrate comprises:
providing a silicon-based growth substrate,
forming the phase change material switches on the growth substrate,
forming thermal actuation guides of the phase change material switches,
forming a metallising level intended to form interconnecting lines and/or radiating metal elements of each phase change material switch, and
transferring a first layer based on one or the other from among molten silica, quartz and a glass having a loss tangent less than 0.005 at frequencies greater than 100 GHz,
if necessary, forming a ground plane on said layer based on one or the other from among molten silica, quartz and a glass having a loss tangent less than 0.005 at frequencies greater than 100 GHz, then,
removing by grinding the growth substrate,
each phase change material switch, each thermal actuation guide and each interconnecting line or radiating metal element being located at least partially encapsulated in silicon oxide.

14. The method according to claim 10, wherein the provision of providing the second substrate comprises:
providing a support substrate based on one or the other from among molten silica, quartz and a glass having a loss tangent less than 0.005 at frequencies greater than 100 GHz, and
forming, on the support substrate, of a metal layer, and
etching the metal layer to form patterns or structurings for each tuneable unit cell to be formed, and
wherein the cutting step relates to the second substrate and consists of cutting pads in the second substrate by rotating around each pattern or structuring.

15. The method according to claim 10, wherein transferring at least one first pad is done by thermocompression of a metal layer of said at least one first pad with a metal layer of the first substrate.

16. The method according to claim 10, wherein transferring at least one first pad is done by remelting metal balls, for example, gold-based, deposited beforehand on at least one from among a metal layer of said at least one first pad and a metal layer of the first substrate.

17. The method according to claim 15, wherein the cutting of said at least two first pads is done in the second substrate.

18. The method according to claim 10, wherein transferring at least one first pad is done by hybrid bonding, said at least one first pad and the first substrate having, at the fixing of said at least one first pad on the first substrate, surface structurings being superposed substantially to one another.

19. The method according to claim 10, wherein transferring at least one first pad is done by remelting metal balls deposited beforehand on at least one from among a metal layer of said at least one first pad and a metal layer of the first substrate, said at least one first pad and the first substrate having, at the fixing of said at least one first pad on the first substrate, surface structurings being superposed substantially to one another.

20. The method according to claim 18, wherein the cutting of said at least two first pads is done in the first substrate.
